(19) United States
(12) Patent Application Publication
(10) Pub. No.: US 2024/0308097 A1
(43) Pub. Date: Sep. 19, 2024

(54) PRESSING BLOCK OF VEGETABLE CUTTER

(71) Applicant: Zhejiang Fullstar Houseware Co.,Ltd., Taizhou (CN)

(72) Inventor: Congqiang LU, Taizhou (CN)

(73) Assignee: Zhejiang Fullstar Houseware Co.,Ltd., Taizhou (CN)

(21) Appl. No.: 18/597,594

(22) Filed: Mar. 6, 2024

(30) Foreign Application Priority Data
Mar. 14, 2023 (CN) 202320494555.0

(51) Int. Cl. B26D 3/18; B26D 3/26

(52) U.S. Cl. CPC B26D 3/185; B26D 3/26

(57) ABSTRACT

Disclosed is a pressing block of a vegetable cutter, including a pressing block base and a plurality of pressing teeth disposed at a bottom of the pressing block base. The pressing block base is provided with a plurality of guiding through-holes along a direction of the pressing teeth, a driving rod penetrating through the pressing block base is slidably disposed in the guiding through-hole, the driving rod has one end connected to a pump cleaning grid and the other end connected to a driving block, the pump cleaning grid is provided with a plurality of mesh holes fitting with the pressing teeth, the pump cleaning grid slidably sleeves the pressing teeth via the mesh holes, and a reset cleaning spring is disposed between the driving block and the pressing block base.

### CROSS-REFERENCE TO RELATED APPLICATIONS

This application claims priority to Chinese Patent Application No. 202320494555.0, filed on Mar. 14, 2023, the content of which is incorporated herein by reference in its entirety.

### TECHNICAL FIELD

The present disclosure relates to the technical field of food processing devices, and relates to a pressing block of a vegetable cutter.

### BACKGROUND

A vegetable cutter is a common type of food processing device, typically includes a base and a pressing cover. A cutting disc is mounted on the base, and a pressing block that cooperates with the cutting disc is disposed on the pressing cover. During use, food is placed on the cutting disc, and then the food is pressed using the pressing cover, allowing blades on the cutting disc to chop the food.

A dicer is a type of vegetable cutter, grid-like blades are disposed on the cutting disc of the dicer, and the bottom of the pressing block is provided with a plurality of square pressing teeth fitting with the grid-like blades. Because a gap between teeth is small, after the use of the dicer, food crumbs remaining in the gap between pressing teeth are difficult to clean.

### SUMMARY

In view of the defects in the related art, the present disclosure provides a pressing block of a vegetable cutter, so as to conveniently clean food crumbs residual between pressing teeth.

To resolve the foregoing technical problem, an objective of the present disclosure is achieved using the following technical solution.

A pressing block of a vegetable cutter is provided, including a pressing block base and a plurality of pressing teeth disposed at a bottom of the pressing block base. The pressing block base is provided with a plurality of guiding through-holes along a direction of the pressing teeth, a driving rod penetrating through the pressing block base is slidably disposed in the guiding through-hole, the driving rod has one end connected to a pump cleaning grid and the other end connected to a driving block, the pump cleaning grid is provided with a plurality of mesh holes fitting with the pressing teeth, the pump cleaning grid slidably sleeves the pressing teeth via the mesh holes, and a reset cleaning spring is disposed between the driving block and the pressing block base.

In the foregoing pressing block of a vegetable cutter, preferably, the driving block and the pump cleaning grid are both parallel to the pressing block base and perpendicular to the pressing teeth.

In the foregoing pressing block of a vegetable cutter, preferably, the driving block and the pump cleaning grid are both square, and four driving rods are distributed as a rectangle.

In the foregoing pressing block of a vegetable cutter, a plurality of guiding plates are disposed in the pressing block base, and the driving block is slidably disposed on the guiding plates along the direction of the pressing teeth. Preferably, the bottom portion and the outside of the guiding plate are integrated with the pressing block base.

In the foregoing pressing block of a vegetable cutter, an end portion on an inner side of at least one of the guiding plates is provided with a guiding pillar, and the driving block is provided with a first opening groove fitting with the guiding pillar. Preferably, the guiding pillar is a cylinder, and the first opening groove is circular. The driving block is further provided with a second opening groove fitting with another guiding plate. Preferably, the second opening groove is in a shape of a strip.

In the foregoing pressing block of a vegetable cutter, a bottom of the driving block is provided with a spring mounting base, a spring mounting groove is disposed at a position of the pressing block base with respect to the spring mounting base, and the reset cleaning spring has one end sleeving the spring mounting base and the other end accommodated in the spring mounting groove.

In the foregoing pressing block of a vegetable cutter, the driving rod and the pump cleaning grid are integrated, and the driving rod is securely connected to the driving block via a fastening bolt.

In the foregoing pressing block of a vegetable cutter, the pump cleaning grid may be made of plastics or metal, preferably, metal.

In the foregoing pressing block of a vegetable cutter, the pressing block base is detachably connected to a pressing cover of the vegetable cutter.

The present disclosure further provides various detachable structures.

In the foregoing pressing block of a vegetable cutter, the pressing block base is provided with a plurality of limiting blocks on a side and a slot on the other side, the limiting block fits with a limiting groove on the pressing cover, and the slot is detachably connected to a clamped head on the pressing cover.

Alternatively, in the foregoing pressing block of a vegetable cutter, the pressing block base is provided with a plurality of limiting blocks on a side and a slot on the other side, the limiting block fits with a limiting groove on the pressing cover, the pressing cover is provided with a clamped-head mounting base, a clamped head snap-fitted with the slot is slidably disposed on the clamped-head mounting base, a reset locking spring is disposed between the clamped head and the clamped-head mounting base, and the clamped head is switched between an unlocking position and a locking position.

Compared with the prior art, the present disclosure has the following beneficial effect.

In the present disclosure, in addition to the existing pressing block, a food residue cleaning structure is provided. The pump cleaning grid fitting with the pressing teeth is moved toward the bottom to completely clean the food residue in the gap between teeth. During use, the driving block is only pressed down to complete cleaning, and thus it has the advantages of a simple structure, convenient operation, and complete cleaning. Further, the present disclosure is provided with the detachable pressing block structure, and the pressing block can be disassembled before cleaning, further facilitating use.

### BRIEF DESCRIPTION OF THE DRAWINGS

FIG. 1 is a three-dimensional diagram according to the present disclosure.

FIG. 2 is a three-dimensional diagram at another angle according to the present disclosure.

FIG. 3 is an exploded view according to the present disclosure.

FIG. 4 is a cross-sectional diagram according to the present disclosure.

FIG. 5 is a three-dimensional diagram of a clamped-head assembly according to the present disclosure.

### DETAILED DESCRIPTION OF THE EMBODIMENTS

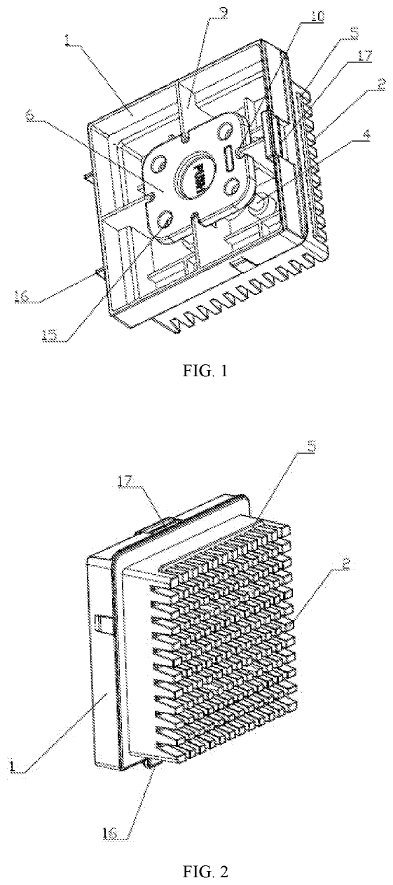

The following further describes the present disclosure with reference to accompanying drawings and a specific embodiment. Refer to FIGS. 1 to 5.

A pressing block of a vegetable cutter is provided, including a pressing block base 1 and a plurality of pressing teeth 2 disposed at a bottom of the pressing block base 1. The pressing block base 1 is provided with a plurality of guiding through-holes 3 along a direction of the pressing teeth 2, a driving rod 4 penetrating through the pressing block base 1 is slidably disposed in the guiding through-hole 3, the driving rod 4 has one end connected to a pump cleaning grid 5 and the other end connected to a driving block 6, the pump cleaning grid 5 is provided with a plurality of mesh holes 7 fitting with the pressing teeth 2, the pump cleaning grid 5 slidably sleeves the pressing teeth 2 via the mesh holes 7, and a reset cleaning spring 8 is disposed between the driving block 6 and the pressing block base 1.

The use manner in this embodiment is as follows. When the food residue needs to be cleaned after the use of the vegetable cutter, the driving block 6 is pressed toward the pressing teeth 2, the driving block 6 drives, via the driving rod 4, the pump cleaning grid 5 to move toward the bottom, while the reset cleaning spring 8 is compressed. Some of the mesh holes 7 of the pump cleaning grid 5 fit with the pressing teeth 2, and connection bars between the mesh holes 7 fill the gaps between the pressing teeth 2 to form an embedded structure. Therefore, when the pump cleaning grid 5 moves to the bottom, the food residue in the gap between the pressing teeth 2 also synchronously moves toward the bottom along with the pump cleaning grid 5 to be discharged outside the pressing block. After the cleaning, the driving block 6 is released, the compressed reset cleaning spring 8 drives the driving block 6 to leave the pressing teeth 2, and the pump cleaning grid 5 is reset.

Preferably, in this embodiment, the driving block 6 and the pump cleaning grid 5 are both parallel to the pressing block base 1 and perpendicular to the pressing teeth 2.

Preferably, in this embodiment, the driving block 6 and the pump cleaning grid 5 are both square, and four driving rods 4 are distributed as a rectangle.

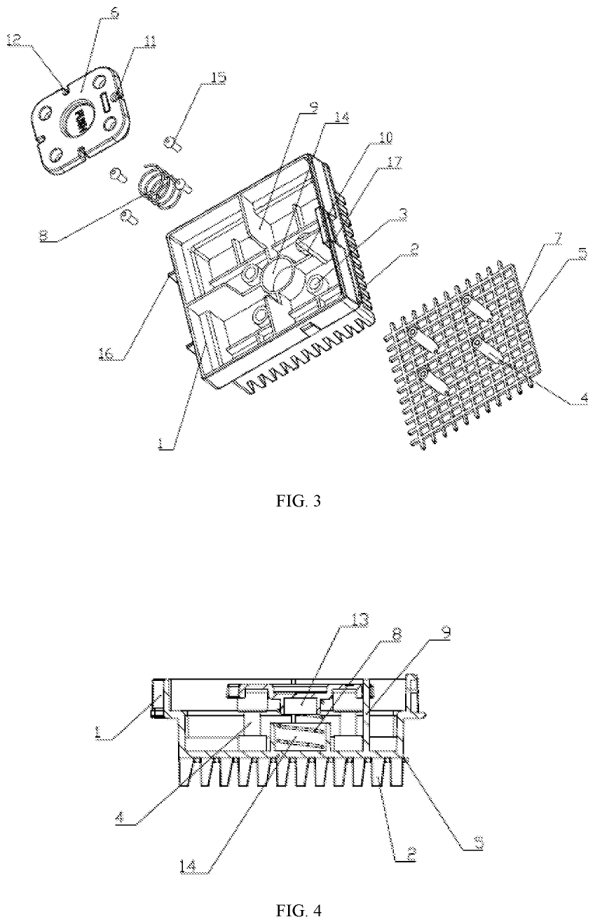

Referring to FIGS. 1 and 3, to enable the driving block 6 to move stably, a plurality of guiding plates 9 are disposed in the pressing block base 1, and the driving block 6 is slidably disposed on the guiding plates 9 along the direction of the pressing teeth 2. Preferably, the bottom portion and the outside of the guiding plate 9 are integrated with the pressing block base 1.

Further, an end portion on an inner side of at least one of the guiding plates 9 is provided with a guiding pillar 10, and the driving block 6 is provided with a first opening groove 11 fitting with the guiding pillar 10. Preferably, the guiding pillar 10 is a cylinder, and the first opening groove 11 is circular. The driving block 6 is further provided with a second opening groove 12 fitting with another guiding plate 9. Preferably, the second opening groove 12 is in a shape of a strip. The arrangement of the guiding pillar and the first opening groove is conducive to determining the orientation of a component during mounting.

Referring to FIG. 4, the mounting structure of the reset cleaning spring 8 is as follows: A bottom of the driving block 6 is provided with a spring mounting base 13, a spring mounting groove 14 is disposed at a position of the pressing block base 1 with respect to the spring mounting base 13, and the reset cleaning spring 8 has one end sleeving the spring mounting base 13 and the other end accommodated in the spring mounting groove 14.

In this embodiment, the driving rod 4 and the pump cleaning grid 5 are integrated, and the driving rod 4 is securely connected to the driving block 6 via a fastening bolt 15. During mounting, the driving rod 4 and the pump cleaning grid 5 go up from the bottom to penetrate through the guiding through-hole 3, the driving block 6 is placed on the guiding plate 9, and the driving block 6 is securely connected using the fastening bolt 15, so as to finish mounting.

In this embodiment, the pump cleaning grid 5 may be made of plastics or metal, preferably, metal.

The pressing block base 1 is detachably connected to the pressing cover of a vegetable cutter, and when the cutter needs to be cleaned, the pressing block can be disassembled from the pressing cover for cleaning.

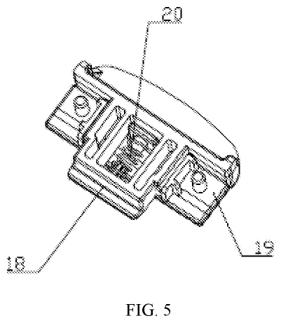

Referring to FIG. 5, the pressing block base 1 is provided with a plurality of limiting blocks 16 on a side and a slot 17 on the other side, the limiting block 16 fits with a limiting groove on the pressing cover, the pressing cover is provided with a clamped-head mounting base 19, a clamped head 18 snap-fitted with the slot 17 is slidably disposed on the clamped-head mounting base 19, a reset locking spring 20 is disposed between the clamped head 18 and the clamped-head mounting base 19, and the clamped head 18 is switched between an unlocking position and a locking position. During disassembly, the clamped head 18 is pulled outward, while the reset locking spring 20 is stretched. The clamped head 18 disengages from the slot 17 to the unlocking position, and the pressing block can be removed for cleaning. During mounting, the limiting block 16 is obliquely placed in the limiting groove, and then the other end of the pressing block is lowered. The clamped head 18 is released and driven by the reset locking spring 20 to move along the direction of the slot 17 into the slot 17, thus achieving locking.

The foregoing embodiment is only a preferred embodiment of the present disclosure, and the protection scope of the present disclosure is not limited thereto. Therefore, any equivalent changes made based on the structure, shape, and principle of the present disclosure should be encompassed within the protection scope of the present disclosure.

What is claimed is:

1. A pressing block of a vegetable cutter, comprising a pressing block base and a plurality of pressing teeth disposed at a bottom of the pressing block base, wherein
the pressing block base is provided with a plurality of guiding through-holes along a direction of the pressing teeth, a driving rod penetrating through the pressing block base is slidably disposed in the guiding through-hole, the driving rod has one end connected to a pump cleaning grid and the other end connected to a driving block, the pump cleaning grid is provided with a plurality of mesh holes fitting with the pressing teeth, the pump cleaning grid slidably sleeves the pressing teeth via the mesh holes, and a reset cleaning spring is disposed between the driving block and the pressing block base.

2. The pressing block according to claim 1, wherein a plurality of guiding plates are disposed in the pressing block base, and the driving block is slidably disposed on the guiding plates along the direction of the pressing teeth.

3. The pressing block according to claim 2, wherein an end portion on an inner side of at least one of the guiding plates is provided with a guiding pillar, the driving block is provided with a first opening groove fitting with the guiding pillar, and the driving block is further provided with a second opening groove fitting with another guiding plate.

4. The pressing block according to claim 1, wherein a bottom of the driving block is provided with a spring mounting base, a spring mounting groove is disposed at a position of the pressing block base with respect to the spring mounting base, and the reset cleaning spring has one end sleeving the spring mounting base and the other end accommodated in the spring mounting groove.

5. The pressing block according to claim 1, wherein the driving rod and the pump cleaning grid are integrated, and the driving rod is securely connected to the driving block via a fastening bolt.

6. The pressing block according to claim 1, wherein the pressing block base is detachably connected to a pressing cover of the vegetable cutter.

7. The pressing block according to claim 6, wherein the pressing block base is provided with a plurality of limiting blocks on a side and a slot on the other side, the limiting block fits with a limiting groove on the pressing cover, and the slot is detachably connected to a clamped head on the pressing cover.

8. The pressing block according to claim 6, wherein the pressing block base is provided with a plurality of limiting blocks on a side and a slot on the other side, the limiting block fits with a limiting groove on the pressing cover, the pressing cover is provided with a clamped-head mounting base, a clamped head snap-fitted with the slot is slidably disposed on the clamped-head mounting base, a reset locking spring is disposed between the clamped head and the clamped-head mounting base, and the clamped head is switched between an unlocking position and a locking position.
